(19) United States
(12) Patent Application Publication
(10) Pub. No.: US 2022/0214978 A1
(43) Pub. Date: Jul. 7, 2022

(54) SERVER-BASED HOTDESKING

(71) Applicant: DisplayLink (UK) Limited, Cambridge - Cambridgeshire (GB)

(72) Inventor: William George ROOSE, Ely - Cambridgeshire (GB)

(21) Appl. No.: 17/611,464

(22) PCT Filed: May 15, 2020
(86) PCT No.: PCT/GB2020/051191

§ 371 Date: Nov. 15, 2021

(30) Foreign Application Priority Data
May 15, 2019 (GB) 1906822.0

(51) Int. Cl. G06F 13/10; G06F 13/40

(52) U.S. Cl. CPC G06F 13/102; G06F 13/4068

(57) ABSTRACT

A docking station configured to enable a host device to access resources provided by or connected to the docking station is disclosed. The resources include one or more peripheral devices, interfaces and/or network connections. The docking station is configured to receive setting information including at least one configuration setting for configuration of interaction between the host device and one or more of the resources. The docking station is also configured to transmit the setting information to the host device for use in configuring the host device to interact with one or more of the resources, when the host device communicatively couples to the docking station.

### BACKGROUND

As patterns of work change, it is becoming more common for offices to be arranged for “hotdesking”, meaning that an individual does not have a designated desk but can connect his or her computing device to any one of a number of workstations and use the resources connected to that workstation. This introduces new problems as users are likely to have particular preferences and requirements for a workstation, and if a user had to reconfigure the workstation every time he or she connects it leads to frustration and wasted time.

The present invention seeks to solve and/or mitigate at least some of these problems.

### SUMMARY

Aspects of the invention are set out in the independent claims and preferred features are set out in the dependent claims.

In one aspect the invention provides a docking station configured to enable a host device to access resources provided by or connected to the docking station, the resources including one or more peripheral devices, interfaces and/or network connections, wherein the docking station is configured to: receive setting information including at least one configuration setting for configuration of interaction between the host device and one or more of the resources, and transmit the setting information to the host device for use in configuring the host device to interact with one or more of the resources when the host device communicatively couples to the docking station.

In embodiments of the invention, a user may thus connect his or her computing device (host) to a docking station (also referred to as a ‘dock’ herein), in order to access peripherals and other resources through the docking station. It will be appreciated that the user may connect the computing device to the docking station using any suitable interface.

The docking station may be further configured to receive the setting information from a remote device. The setting information may be recorded at another docking station, and the remote device may be the other docking station or a server arranged to receive the setting information from the other docking station.

The docking station may be further configured to receive, from the remote device, identification information associated with the setting information. The docking station may be further configured to identify, when the host device is communicatively coupled to the docking station, the setting information to be transmitted to the host device based on the associated identification information.

The docking station may be configured to obtain identification information from the connected host device, and to select the setting information based on its associated identification information and the obtained identification information.

The docking station may be configured to select one of a set of configurations each comprising setting information based on the identification information obtained from the host device.

The docking station may be configured to: detect connection of the host device; and in response to detecting connection: select the configuration from locally stored configurations in dependence on the obtained identification information; or retrieve the configuration from a remote server device over a network in dependence on the obtained identification information.

The docking station may be configured to select a configuration having associated identification information matching the obtained identification information, optionally based on one of: the associated identification information specifying the same host device or user specified in the obtained identification information; the associated identification information specifying the same host category or user category specified in the obtained identification information; the obtained identification information specifying a host device or user identified as a member of a host category or user category specified in the associated identification information.

The identification information may be information for identifying at least one of: a host device, a user of a host device; a host device category; and a user category.

In another aspect the invention provides a docking station configured to enable a host device to access resources provided by or connected to the docking station, the resources including one or more peripheral devices, interfaces and/or network connections, wherein the docking station is configured to: receive, from the host device, setting information including at least one configuration setting used to control interaction between the host device and one or more of the resources, and transmit the setting information to a remote device for use in configuration of a host device when connected to a further docking station.

The remote device may be the further docking station or a server arranged to provide the setting information to the further docking station.

The docking station may be further configured to receive, from the host device, identification information related to the host device or a user of the host device. The docking station may be further configured to determine whether to store the setting information based on the identification information.

The docking station may be further configured to determine whether to transmit the setting information to the remote device based on the identification information.

The docking station may be further configured to store or transmit the setting information in association with the identification information.

The docking station may be further configured to store authorization information for identifying a host device or a user permitted to apply configuration changes.

The docking station may be further configured to: determine whether to store the setting information based on the authorization information; and/or determine whether to transmit the setting information to the remote device based on the authorization information.

The setting information may comprise information that identifies a display configuration.

The information that identifies a display configuration may comprise at least one of: an arrangement of display panels and a display resolution.

The setting information may comprise at least one of: a network setting, an audio input setting, an audio output setting, a charging setting, and a setting for a peripheral device.

In another aspect the invention provides a system comprising a plurality of docking stations including a first docking station and a second docking station, wherein the docking stations are each configured to enable the host device to access resources provided by or connected to the respective docking station, the resources including one or more peripheral devices, interfaces and/or network connections; wherein the first docking station is configured to: receive, from a host device connected to the first docking station, setting information including at least one configuration setting used to control interaction between the host device and one or more of the resources of the first docking station; wherein the system is arranged to communicate the setting information from the first docking station to the second docking station via a network, for use in configuration of the host device when communicatively coupled to the second docking station; and wherein the second docking station is configured to: receive the setting information, and transmit the setting information to the host device when the host device communicatively couples to the second docking station.

The system may be configured for transmitting the setting information directly from the first docking station to the second docking station, or the system may be configured for transmitting the setting information from the first docking station to the second docking station via a server.

The first docking station may be configured to receive, from the host device, identification information related to the host device or a user of the host device; and the system may be configured to communicate the setting information to a subset of the plurality of docking stations based on the identification information.

In another aspect the invention provides a configuration server arranged to communicate with a plurality of docking stations via a network, the server configured to: receive a configuration from a first docking station, the configuration comprising setting information received from a given host device connected to the first docking station; and transmit the configuration to a further docking station for use in configuring interaction between the further docking station and a host device when connected to the further docking station, optionally wherein the host device is the given host device.

The transmitting step may be performed: in response to receipt of the configuration from the first docking station, or in response to a request for the configuration received from the further docking station upon connection of the host device to the further docking station.

In another aspect the invention provides a method performed at a docking station configured to enable a host device to access resources provided by or connected to the docking station, the resources including one or more peripheral devices, interfaces and/or network connections, the method comprising: receiving setting information including at least one configuration setting for configuration of interaction between the host device and one or more of the resources, and transmitting the setting information to the host device for use in configuring the host device to interact with one or more of the resources when the host device communicatively couples to the docking station.

In another aspect the invention provides a method performed at a docking station configured to enable a host device to access resources provided by or connected to the docking station, the resources including one or more peripheral devices, interfaces and/or network connections, the method comprising: receiving, from the host device, setting information including at least one configuration setting used to control interaction between the host device and one or more of the resources, and transmitting the setting information to a remote device for use in configuration of a host device when connected to a further docking station.

In another aspect the invention provides a computer readable medium comprising software code adapted, when executed on a data processing apparatus, to perform one of the aforementioned methods.

A setting may be, for example, any suitable configuration parameter configuring the operation of a host device, a dock, or a peripheral device. The setting information may comprise a plurality of such configuration parameters/settings.

In some examples, a method of propagating docking settings and user profiles between docking stations in a network, comprises:
1. A number of docking stations are connected together in a network;
2. A user connects a host device to a docking station, either directly or over a network;
3. The user changes settings on the connected host device;
4. The host device transmits the changed settings to the docking station;
5. The docking station records the changed settings and propagates them to other docking stations on the network;
6. The user connects the host device to a second docking station;
7. The second docking station uses the propagated settings.

In this method, the docking settings, which may include display configuration, network settings, audio input and output settings, charging settings, and similar, may be stored on the docking stations rather than the host device. The fact that the settings are propagated between docking stations provides an improved experience for the user as the same settings may be applied to his or her desktop configuration regardless of which docking station he or she connects to.

A collection of settings may be associated with a specific user, a specific host device, or a category of users or host devices, reducing the amount of configuration required as an administrator need only change each category of settings once to apply the change to every connection in that category on the network. The docking stations may also use a specific white-list to determine which users or host devices are permitted to change the settings, and this may mean that only permitted users can change settings at all or that only settings changed by permitted users will propagate across the network. For example, the user might be an IT manager with special privileges to change any settings and have the changes propagate across an entire network or might be an ordinary user who can only change a limited number of settings for the duration of a session on that particular docking station.

Naturally, it could be possible to alter the white-lists as appropriate to grant or remove particular privileges to groups and individuals as required. Furthermore, docking stations could be grouped such that where settings propagate they do so to specific groups of docking devices rather than every connected docking device. These mechanisms might then be combined such that, for example, an IT manager can change a setting and propagate it through the entire network, but a team leader could change a setting and have it propagate only to docking stations in a particular part of an office.

Any system feature as described herein may also be provided as a method feature, and vice versa. As used herein, means plus function features may be expressed alternatively in terms of their corresponding structure.

Any feature in one aspect of the invention may be applied to other aspects of the invention, in any appropriate combination. In particular, method aspects may be applied to system aspects, and vice versa. Furthermore, any, some and/or all features in one aspect can be applied to any, some and/or all features in any other aspect, in any appropriate combination.

It should also be appreciated that particular combinations of the various features described and defined in any aspects of the invention can be implemented and/or supplied and/or used independently.

### BRIEF DESCRIPTION OF THE DRAWINGS

Embodiments will now be described, by way of example only and with reference to the accompanying drawings, in which:

FIG. 1 illustrates an exemplary system of four docking stations connected to a network;

FIG. 2 illustrates an exemplary block diagram of a docking station;

FIG. 3 illustrates a flowchart of an exemplary process;

FIG. 4a illustrates an exemplary network topology;

FIG. 4b illustrates a further exemplary network topology;

FIG. 5 illustrates a flowchart of a further exemplary process; and

FIG. 6 illustrates a block diagram of an exemplary computer system.

### DETAILED DESCRIPTION OF THE DRAWINGS

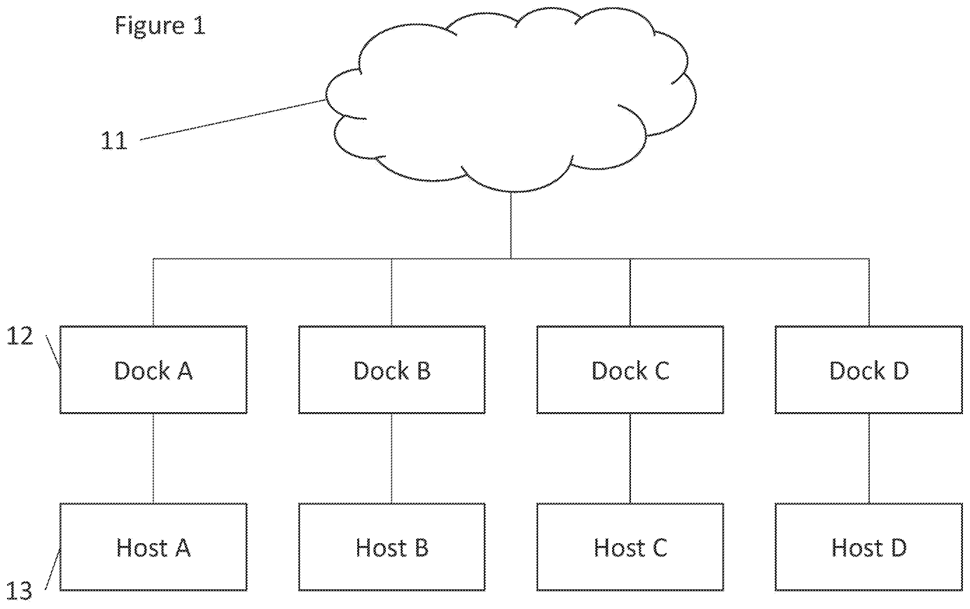

FIG. 1 illustrates an exemplary system of four docking stations [12] connected to a network [11]. This may be a Local Area Network (LAN) or a Wide Area Network (WAN) including the Internet, that enables the docking stations [12] to communicate with each other. However, it will be appreciated that any other suitable network may be used. There are likely to be other devices such as servers and user interface devices such as printers connected to the network [11], but they are not shown here.

Each docking station [12], also referred to as a ‘dock’, can be connected to a computing device known as a host [13]. This computing device may be a conventional computer such as a “desktop” or laptop computer, or it may be another device such as a mobile phone or tablet. The hosts [13] are connected to their respective docking stations [12] so they can access connected devices and the network [11].

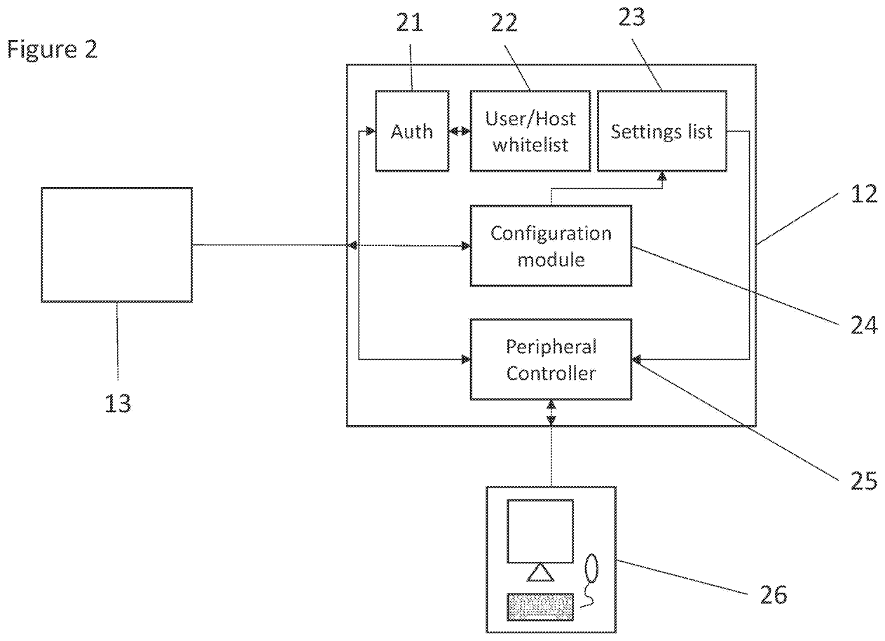

FIG. 2 illustrates an exemplary block diagram of a docking station [12], such as those shown in FIG. 1. As previously described, the docking station [12] can be connected to a host computing device [13], and it is shown connected here. The docking station [12] provides access for a connected host device to a set of resources, which may include any of:
one or more peripheral devices [26] (such as display devices, input devices etc.) connected to the docking station;
one or more network interfaces provided by the docking station for connection to external networks, which may include wired network interfaces (e.g. Ethernet) and wireless network interfaces (e.g. WiFi/Bluetooth);
media interfaces, e.g. audio or video connection ports;
other wired/wireless interfaces, e.g. USB interfaces, near-field communication modules etc.;
wired/wireless power supply outputs/charging interfaces;
internal processing devices, e.g. audio/video processors, codecs etc., to enable enhanced processing functions for the connected host device.

The above are provided by way of example, and any other type of resources to which the docking station can provide access may be supported (either by directly including the resource in the docking station or providing a connection to the resource). In the following, the discussion focusses on connected peripherals but it will be understood that the described techniques apply to other types of resources. Communication with and/or control of these resources, such as peripherals [26], by the host and/or docking station is governed (at least in part) by a set of configuration settings which are configurable by a host device and/or its user.

The docking station [12] also includes several internal processing modules and data structures. Data structures are stored in a memory of the device. Processing modules may be in the form of software modules (e.g. executable code modules stored in device memory executed by a processor of the device), though some or all of their functions could alternatively be implemented in hardware. The number and arrangement of processing modules and data structures is by way of example and functionality can be divided across different numbers of modules/data structures in any suitable manner depending on the embodiment.

The first is an authorisation module [21]. This is connected to a user/host whitelist [22], which comprises authorisation information for identifying a list of the users and/or hosts which are allowed to connect to the docking station [12] and change its settings. The list of users/hosts that can connect and the list of users/hosts that can change the docking station's [12] settings may be different lists such that only a limited number of those who can connect can change settings. When a host device [13] is connected and/or a user logs on, the authorisation module [21] receives the appropriate credentials and compares them to the whitelist [22] in order to determine the privileges of the user and/or host [13]. Note that instead of a whitelist another data structure representing user/host privileges may be used, e.g. a table of users/hosts with associated privileges, indicating, for example by way of a set of flags, whether a given user/host can connect to the docking station and/or whether the user/host can modify setting stored at the docking station.

The docking station [12] also includes a configuration module [24], which receives changed settings from the host computing device [13] and updates a connected list of settings [23]. This list of settings may be formatted as a lookup table keyed by an identification of the user and/or host [13] such that every user-host combination might have a unique set of settings, or it may be a single list such as a lookup table keyed by, for example, the type of peripheral such that all users have the same—for example—audio settings. It might also be a combination of the two such that there are some identified users and/or hosts and all others have a default list of settings. The configuration module [24] receives a setting or updated setting(s) from the connected host device [13] and stores them in the settings list [23] as appropriate. Whilst the settings have been described as being stored as a list, it will be appreciated that the settings may be stored in any other suitable format.

The docking station [12] also includes a peripheral controller [25] which transfers data between the connected host device [13] and peripherals [26] as well as controlling the peripherals [26] and the connection between the docking station [12] and the peripherals [26]. Accordingly, as well as being communicatively connected to the host device [13], the peripheral controller [25] has access to the settings list [23] so it is able to fetch the appropriate settings from the list [23] and impose them on the peripherals [26] and the connections to the peripherals [26].

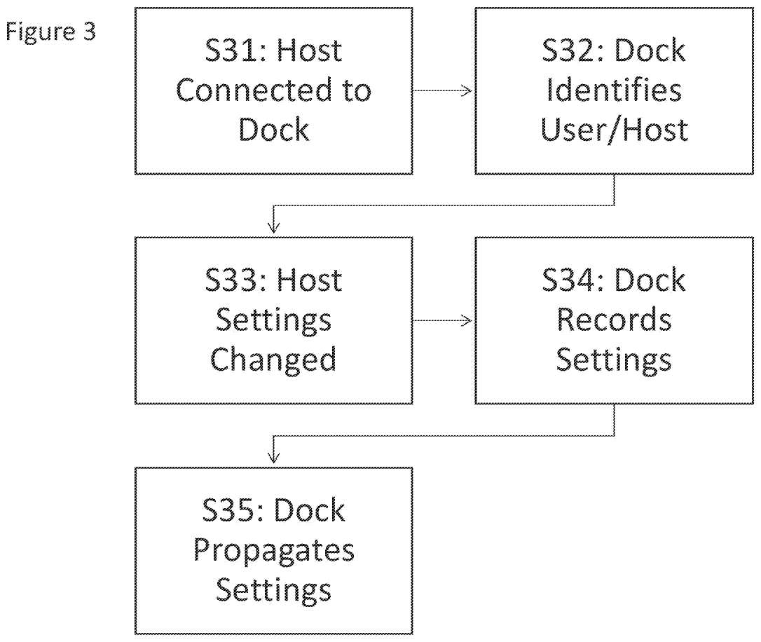

FIG. 3 illustrates an exemplary process which could be used to propagate docking station settings through a network [11], such as that shown in FIG. 1.

At Step S31, a host [13] is connected to a docking station [12]. For example, this might be Host A [13] connected to Dock A [12] in FIG. 1. The connection may be wired or wireless by any type of connection that is capable of carrying data and signals between the host [13] and the docking station [12].

At Step S32, the docking station [12] identifies one or both of the user and the host [13]. This may be via the user entering authentication details such as a password via the host [13] or a connected peripheral, or the docking station [12] might determine an identifier of the host [13] such as:
A type of device, for example laptop, mobile phone, or tablet;
An owner or issuer, such as an employer or manufacturer;
A unique identifier such as mac address.

In the exemplary docking station [12] illustrated schematically in FIG. 2, the authentication details and/or identifier are received by the authorisation module [21] and compared to data in the user/host whitelist [22]. For example, the authorisation module [21] may receive a User ID and Password entered by the user via a keyboard [26] connected to the docking station [12] together with an ID of an issuer (for example, a manufacturer of the host device) of the connected host [13]. It can then compare these combined data with a User ID/Password/Issuer ID entry in the user/host whitelist [22]. If the User ID and Password match, in this example embodiment, the user is permitted to edit settings on the docking station [12], and if the Issuer ID matches the host [13] is permitted to edit settings on the docking station [12], and if all three match a single entry the user is permitted to use the host [13] to edit settings on to the docking station [12] and the process can continue.

When identifying the user, the docking station [12] may also simply determine whether the user belongs to a category of users. For example, an ordinary employee might not have permission to change settings on the docking station [12] while a member of the IT team does. In this case, the authorisation module [21] might just determine whether the user is a member of the IT team, either by identifying the user or by determining whether the device the user is using is issued to the IT team.

This allows the docking station [12] to determine whether the host/user combination is authorized to change settings and have those settings propagated through the network [11]. If not, the user/host combination may only be permitted to change settings locally, and this may also mean that the new settings are not stored past the end of the current session. Alternatively, the user/host combination may not be permitted to change settings at all and any changes would therefore be rejected by the docking station [12]. The process would therefore end at this Step.

At Step S33, the user changes docking settings on the host [13]. This may include:
Arrangement of connected display panels
Permitted peripherals
USB activation
Network settings such as whether Wi-Fi is enabled while Ethernet is in use
Display resolution

These changes are transmitted to the docking station [12].

At Step S34 the configuration module [24] on the docking station [12] records the new settings in the settings list [23]. This means that it changes its own behaviour and the behaviour of its connected devices appropriately, including the host [13]. For example, if the settings list contains such an instruction, the peripheral controller [25] might send a signal to any host [13]—including those connected subsequently if the settings persist past the end of the current session—to tum off its USB connection capabilities, or in another example it might reduce the resolution of the connected display panels [26] or modify the behaviour of the keyboard [26].

At Step S35, the docking station [12] propagates the changed settings through the network [11]. This may mean associating the changed settings with the user or the host [13] or the user/host pair such that they will only be applied when the same user connects to a docking station [12], the same host [13] is connected to a docking station [12], or the combination of the two, as appropriate. Alternatively, the same settings might be applied in all cases. This might depend on the identification of the user and/or host [13] as previously mentioned. For example, a user who is a member of the IT team might be able to apply settings that will be used in all cases across the network while a user who, for example, has disability accommodation requirements might have permission to change the global settings as appropriate for him or her in which case those settings would only apply when he or she connects to a docking station [12].

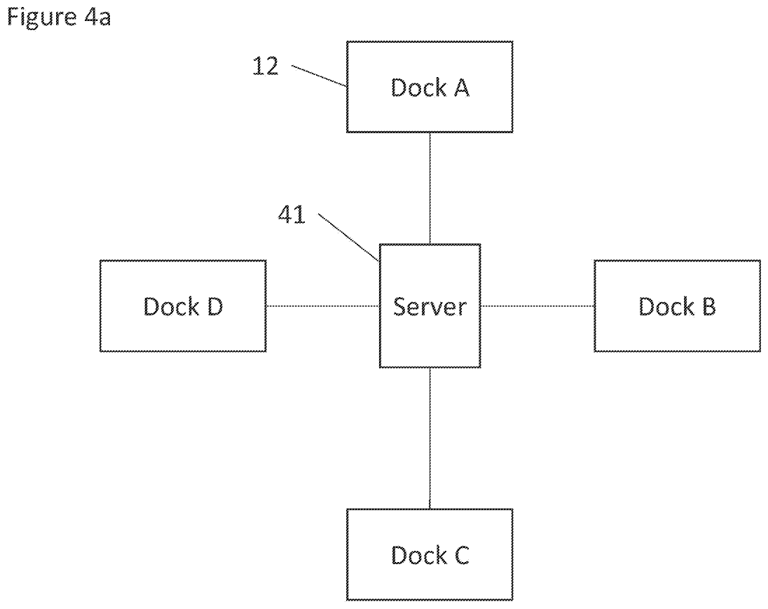

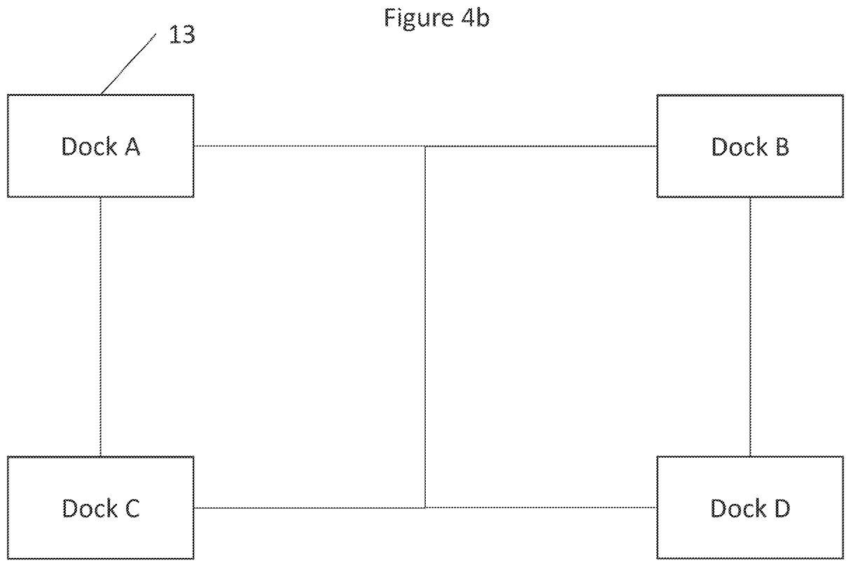

The exact mechanism of the propagation of settings depends on the network topology. Examples are shown in FIGS. 4a and 4b.

FIG. 4a shows an exemplary network topology in which the four docking stations [12] illustrated in FIG. 1 are connected to a central server [41]. The connections may be over any suitable media or network connection, wired or wireless, including the internet. There are also likely to be other devices in the network, but they are not shown here.

In this network topology, Step S35 as described in FIG. 3 could involve the configuration module [24], possibly via the peripheral controller [25], uploading the changed settings to the server [41], possibly changing any settings already stored at the server. A docking station [12] in this system may not include a settings list [23] but instead fetch settings from the central server [41], for example upon connection to a host device. If the settings are associated with a particular user and/or host [13], they may be stored on the server [41] in a table keyed by the identification used to identify the user and/or host [13]. Alternatively, docking stations may maintain local settings lists, with the central server propagating settings uploaded from one docking station to other docking stations in the network.

FIG. 4b shows a further exemplary network topology in which the four docking stations [12] shown in FIG. 1 are connected directly to one another in a peer-to-peer relationship. As in FIG. 4a, the connections may be over any suitable media or network connection and there are also likely to be other devices in the network [11].

In this network topology, step S35 of FIG. 3 could involve the docking station [12] propagating the changed settings by transmitting the changed settings directly to each docking station [12] individually, possibly updating any lookup tables such as the settings list [23] stored in those docking stations [12]. This version of the system does not require a central server [41] and so settings are immediately available at each of the docking stations upon the connection of a new host [13], though it is necessary to update settings in multiple places.

Upon receipt at a remote docking station, the propagated settings are used by the remote docking station to configure the docking station and/or a connected host device upon connection of the host device to the remote docking station. Depending on the configured resource, this may involve configuration of the docking station itself, configuration of connected peripheral devices, and/or transmission of settings to the host device to configure the host device itself (e.g. to configure a display panel arrangement/resolution to override a default configuration set in the operating system of the host device). Application of the received configuration settings at the host device may be automatic or may be controllable by the host device or its user. The connected host device may be the same host device from which the settings were originally obtained (in other previously described examples, settings from one host may be applied to different hosts).

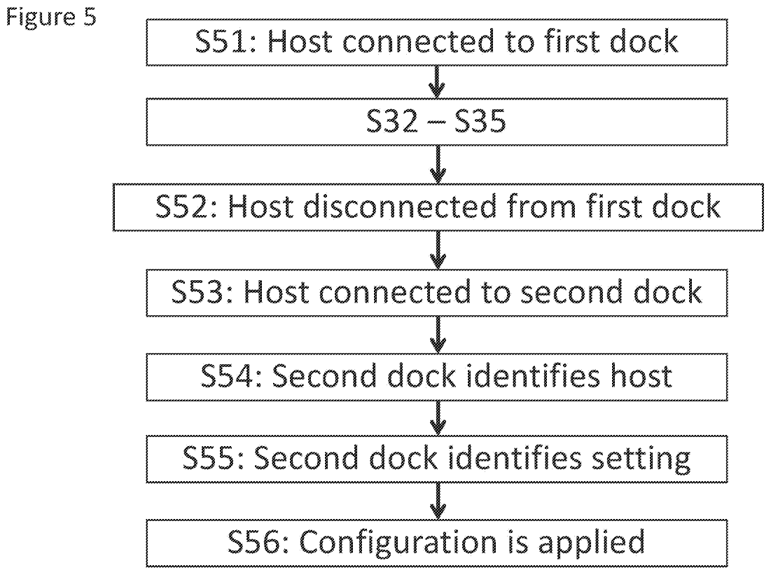

An exemplary operation of the system will now be described by reference to the flow chart shown in FIG. 5. First, in step S51, a host device [13] is communicatively coupled to a first docking station [12] of the system (for example, in the system illustrated in FIG. 1).

After the host device [13] has been connected to the first docking station [12] steps S32 to S35 are performed. Steps S32 to S35 have been previously described with reference to FIG. 3, and so are not described in detail again here. In step S35 the first docking [12] station propagates the setting information, in association with identification information related to the host device, to a second docking station of the system. It will be appreciated that the first docking station [12] may transmit the setting information directly to the second docking station, for example in the system illustrated in FIG. 4b. Alternatively, the first docking station [12] may transmit the setting information to the second docking station via a server [ 41], for example in the system illustrated in FIG. 4a.

In step S52 the host device [13] is disconnected from the first docking station [12]. In step S53 the host device is connected to the second docking station [12]. For example, the first docking station [12] may be Dock A of FIG. 1 and the second docking station may be Dock B of FIG. 1.

In step S54 the second docking station identifies the host device [13]. For example, the second docking station may receive, from the host device [13] information comprising an identifier of the host device or an identifier of a user of the host device.

In step S55 the second docking station identifies the setting information received from the first docking station [12], based on the determined identity of the host device [13], and the identification information associated with the setting information. The identified setting information may relate to, for example, a configuration of display devices or other peripheral devices [26] connected to the second docking station [12].

In step S56 a configuration specified by the setting information is applied. The docking station [12] may transmit the configuration to the host device [13], and the host device [13] may determine whether or not to apply the received configuration. Alternatively, the docking station [12] may determine, independently of the host device [13], to apply the identified configuration.

It will be appreciated that the propagation of the setting information from the first docking station [12] to the second docking station beneficially reduces the burden on a user of the host device [13] to configure settings when the host device [13] is connected to the second docking station [12].

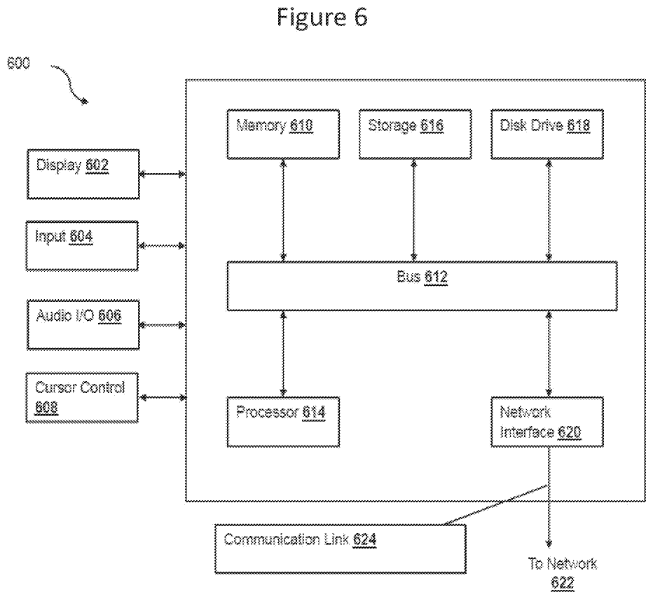

FIG. 6 is a block diagram of a computer system 600 suitable for implementing one or more embodiments of the present disclosure, including the host device [13], the docking station [12] or the server [41]. In various implementations, the host [13] may include a mobile cellular phone, personal computer (PC), laptop, wearable computing device, etc. adapted for wireless communication, and each of the host [13], docking station [12] and the server [41] may include a network computing device. Thus, it should be appreciated that these devices [12, 13, 41] may be implemented as the computer system 600 in a manner as follows.

The computer system 600 includes a bus 612 or other communication mechanism for communicating information data, signals, and information between various components of the computer system 600. The components include an input/output (I/O) component 604 that processes a user action, such as selecting keys from a keypad/keyboard, selecting one or more buttons or links, etc., and sends a corresponding signal to the bus 612. The (I/O) component 604 may also include an output component, such as a display 602 and a cursor control 608 (such as a keyboard, keypad, mouse, etc.). An optional audio input/output component 606 may also be included to allow a user to use voice for inputting information by converting audio signals. The audio I/O component 606 may allow the user to hear audio. A transceiver or network interface 620 transmits and receives signals between the computer system 600 and other devices via network 622. In one embodiment, the transmission is wireless, although other transmission mediums and methods may also be suitable. A processor 614, which can be a micro-controller, digital signal processor (DSP), or other processing component, processes these various signals, such as for display on the computer system 600 or transmission to other devices via a communication link 624. The processor 614 may also control transmission of information, such as cookies or IP addresses, to other devices.

The components of the computer system 600 also include a system memory component 610 (e.g., RAM), a static storage component 616 (e.g., ROM), and/or a disk drive 618 (e.g., a solid-state drive, a hard drive). The computer system 600 performs specific operations by the processor 614 and other components by executing one or more sequences of instructions contained in the system memory component 610. For example, the processor 614 could be utilised to perform the functions of the configuration module [24] of the docking station [12], the described server functions for receiving/propagating configuration settings, or the various functions of a host device.

Executable logic for performing any described functions may be encoded in a computer readable medium, which may refer to any medium that participates in providing instructions to the processor 614 for execution. Such a medium may take many forms, including but not limited to, non-volatile media, volatile media, and transmission media. In various implementations, non-volatile media includes optical or magnetic disks, volatile media includes dynamic memory, such as the system memory component 610, and transmission media includes coaxial cables, copper wire, and fiber optics, including wires that comprise the bus 612. In one embodiment, the logic is encoded in nontransitory computer readable medium, such as a magnetic or optical disk or other magnetic/optical storage medium, or FLASH or other solid-state memory (e.g. integrated into a device or in the form of a memory card). In one example, transmission media may take the form of acoustic or light waves, such as those generated during radio wave, optical, and infrared data communications.

In various embodiments of the present disclosure, execution of instruction sequences to practice the present disclosure may be performed by the computer system 600. In various other embodiments of the present disclosure, a plurality of computer systems 600 coupled by the communication link 624 to the network (e.g., such as a LAN, WLAN, PTSN, and/or various other wired or wireless networks, including telecommunications, mobile, and cellular phone networks) may perform instruction sequences to practice the present disclosure in coordination with one another.

The above embodiments and examples are to be understood as illustrative examples. Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A docking station configured to enable a host device to access resources provided by or connected to the docking station, the resources including one or more peripheral devices, interfaces and/or network connections, wherein the docking station is configured to:
receive setting information including at least one configuration setting for configuration of interaction between the host device and one or more of the resources, and
transmit the setting information to the host device for use in configuring the host device to interact with one or more of the resources when the host device communicatively couples to the docking station.

2. The docking station according to claim 1, wherein the docking station is further configured to receive the setting information from a remote device.

3. The docking station according to claim 2, wherein the setting information is recorded at another docking station, and wherein the remote device is the other docking station or a server arranged to receive the setting information from the other docking station.

4. The docking station according to claim 2, wherein the docking station is further configured to receive, from the remote device, first identification information associated with the setting information.

5. The docking station according to claim 4, wherein the docking station is further configured to identify, when the host device is communicatively coupled to the docking station, the setting information to be transmitted to the host device based on the first identification information.

6. The docking station according to claim 4, wherein the docking station is configured to obtain second identification information from the host device, and to select the setting information based on the first identification information received from the remote device and the second identification information obtained from the host device.

7. The docking station according to claim 6, wherein the docking station is configured to select, based on the second identification information, one of a plurality of configurations each comprising respective setting information.

8. The docking station according to claim 7, wherein the docking station is configured to:
detect a connection with the host device; and
retrieve the selected configuration in response to detecting the connection with the host device, wherein the selected configuration is retrieved from local storage or a remote server device or network.

9. The docking station according to claim 7, wherein the selected configuration is associated with the first identification information, and wherein:
the first identification information specifies the same host device or user specified in the second identification information;
the first identification information specifies the same host category or user category specified in the second identification information; or
the second identification information specifies a host device or user identified as a member of a host category or user category specified in the first identification information.

10. The docking station according to claim 4, wherein the first identification information identifies at least one of: a host device, a user of a host device, a host device category, and a user category.

11. A docking station configured to enable a host device to access resources provided by or connected to the docking station, the resources including one or more peripheral devices, interfaces and/or network connections, wherein the docking station is configured to:
receive, from the host device, setting information including at least one configuration setting used to control interaction between the host device and one or more of the resources, and
transmit the setting information to a remote device for use in configuration of the host device when connected to a further docking station.

12. The docking station according to claim 11, wherein the remote device is the further docking station or a server arranged to provide the setting information to the further docking station.

13. The docking station according to claim 11, wherein the docking station is further configured to receive, from the host device, identification information related to the host device or a user of the host device.

14. The docking station according to claim 13, wherein the docking station is further configured to determine whether to store the setting information based on the identification information.

15. The docking station according to claim 13, wherein the docking station is further configured to determine whether to transmit the setting information to the remote device based on the identification information.

16. The docking station according to claim 13, wherein the docking station is further configured to store or transmit the setting information in association with the identification information.

17. The docking station according to claim 11, wherein the docking station is further configured to store authorization information for identifying a host device or a user permitted to apply configuration changes.

18. The docking station according to claim 17, wherein the docking station is further configured to:
determine whether to store the setting information based on the authorization information; or
determine whether to transmit the setting information to the remote device based on the authorization information.

19. The docking station according to claim 11, wherein the setting information comprises information that identifies at least one of an arrangement of display panels and a display resolution.

20. (canceled)

21. The docking station according to claim 11, wherein the setting information comprises at least one of: a network setting, an audio input setting, an audio output setting, a charging setting, and a setting for a peripheral device.

22-29. (canceled)
